(19) United States
(12) Patent Application Publication
(10) Pub. No.: US 2026/0228043 A1
(43) Pub. Date: Aug. 6, 2026

(54) METHOD, APPARATUS, AND SYSTEM FOR ALLOCATING HARDWARE RESOURCES TO PROCESS VIDEO STREAMS

(71) Applicant: NEC Corporation, Tokyo (JP)

(72) Inventors: Jiyan WU, Singapore (SG); Masafumi WATANABE, Tokyo (JP)

(73) Assignee: NEC Corporation, Tokyo (JP)

(21) Appl. No.: 19/149,142

(22) PCT Filed: Feb. 13, 2024
(86) PCT No.: PCT/JP2024/004726

§ 371 Date: Jul. 18, 2025

(30) Foreign Application Priority Data
Mar. 8, 2023 (SG) 10202300627Q

(51) Int. Cl. G06F 9/50; G06V 10/40; G06V 10/764; G06V 10/82; H04N 7/18

(52) U.S. Cl. CPC G06F 9/5005; G06V 10/40; G06V 10/764; G06V 10/82; H04N 7/181; G06V 2201/07

(57) ABSTRACT

A method of allocating hardware resources to process a plurality of video streams generated by a plurality of video capturing apparatuses is provided. The method includes: receiving an indication to configure each of the plurality of video capturing apparatuses to detect one or more target attributes of an object that appears in a video stream generated by the corresponding video capturing apparatus; selecting an attribute detection module configured to detect the one or more target attributes of the object according to the indication; and allocating one or more of the hardware resources to the attribute detection module to process the video stream and detect the one or more target attributes of the object.

### TECHNICAL FIELD

The present disclosure relates to a hardware resources allocation method, apparatus and a system, and more particularly, the present disclosure relates to a method, an apparatus, and a system for allocating hardware resources to process a plurality of video streams generated by a plurality of video capturing apparatuses.

### BACKGROUND ART

Vision analytic, for example, person/object classification and action recognition, is an important application with the wide deployment of smart camera systems. Generally, the video streams are pulled from surveillance cameras to the analytic server running one or more neural network models based on the hardware resources (e.g., GPU, CPU, RAM, etc.) to perform video analytic tasks/functions and predict the vision analytic results for end-users.

In an event where a larger number of surveillance cameras are deployed on different locations for vision analytic tasks/functions, for example, action recognition and object classification, the different video streams generated by the cameras need to be processed with different video analysis tasks/functions. If all the camera video streams are processed with the same neural network models to carrying out the same video analysis tasks/functions that recognizes/detects the same set of target attributes, the different application requirements may not be satisfied or some hardware resources will be wasted; whereas, if all the camera video streams are processed with different neural network models to execute different video analysis tasks/functions that recognizes/detects different set of target attributes, the deployment complexity will be significantly higher if the neural network models require different libraries/environments.

### SUMMARY OF INVENTION

### Technical Problem

There is thus a need to develop a method, apparatus and system for allocating hardware resources to process a plurality of video streams generated by a plurality of video capturing apparatuses, to address issues and optimize hardware resource utilization of vison analytic tasks using flexible neural network model configurations.

Furthermore, other desirable features and characteristics will become apparent from the subsequent detailed description and the appended claims, taken in combination with the accompanying drawings and this background of the disclosure.

### Solution to Problem

In a first aspect, the present disclosure provides a method of allocating hardware resources to process a plurality of video streams generated by a plurality of video capturing apparatuses, the method comprising: receiving an indication to configure each of the plurality of video capturing apparatuses to detect one or more target attributes of an object that appears in a video stream generated by the corresponding video capturing apparatus; selecting an attribute detection module configured to detect the one or more target attributes of the object according to the indication; and allocating one or more of the hardware resources to the attribute detection module to process the video stream and detect the one or more target attributes of the object.

In a second aspect, the present disclosure provides an apparatus for allocating hardware resources to process a plurality of video streams generated by a plurality of video capturing apparatuses, the apparatus comprising: at least one processor; and at least one memory including computer program code, wherein the at least one memory and the computer program code are configured to, with at least one processor, cause the apparatus at least to: receive an indication to configure each of the plurality of video capturing apparatuses to detect one or more target attributes of an object that appears in a video stream generated by the each of the plurality of video capturing apparatuses; select an attribute detection module configured to detect the one or more target attributes of the object according to the indication; and allocate one or more of the hardware resources to the attribute detection module to process the video stream and detect the one or more target attributes of the object.

In a third aspect, the present disclosure provides a system for allocating hardware resources to process a plurality of video streams comprising the apparatus according to the second aspect and a plurality of video capturing apparatuses configured to generate the plurality of video streams.

Additional benefits and advantages of the disclosed example embodiments will become apparent from the specification and drawings. The benefits and/or advantages may be individually obtained by the various example embodiments and features of the specification and drawings, which need not all be provided in order to obtain one or more of such benefits and/or advantages.

### BRIEF DESCRIPTION OF DRAWINGS

Example embodiments of the disclosure will be better understood and readily apparent to one of ordinary skill in the art from the following written description, by way of example only, and in conjunction with the drawings.

FIG. 1 shows a schematic diagram illustrating an overview of a process for allocating hardware resources to process video streams generated by cameras.

FIG. 2 shows a floor plan of a premise where a video analytic system involving multiple cameras is deployed.

FIG. 3 shows a diagram illustrating a process of conventional video analytic system to detect a target attribute of an object from each camera using a same neural network model.

FIG. 4 illustrates a block diagram of a system for allocating hardware resources to process a plurality of video streams generated by a plurality of video capturing apparatuses according to various example embodiments of the present disclosure.

FIG. 5 shows a diagram illustrating a process for detecting a target attribute of an object from multiple video streams generated by multiple cameras.

FIG. 6 shows a flowchart illustrating a process for allocating hardware resources to process a plurality of video streams generated by a plurality of video capturing apparatuses according to various example embodiments of the present disclosure.

FIG. 7 shows a block diagram illustrating a system for recognizing an action of an object from a first plurality of video streams according to various example embodiments of the present disclosure.

FIG. 8 shows a diagram illustrating a process for detecting a target action of an object from a video stream generated by a camera according to the first example embodiment of the present disclosure.

FIG. 9 shows a diagram illustrating three different order interaction levels according to an example embodiment.

FIG. 10 shows a diagram illustrating an example graphical user interface according to the first example embodiment of the present disclosure.

FIG. 11 shows a diagram illustrating a process for detecting a target action of an object from a video stream generated by a camera according to a second example embodiment of the present disclosure.

FIG. 12 shows a diagram illustrating neural network layers according to an example embodiment of the present disclosure.

FIG. 13 shows a diagram illustrating an example graphical user interface according to the second example embodiment of the present disclosure.

FIG. 14 shows a schematic diagram of an exemplary computing device suitable for use to execute the method in FIG. 6 and implement the apparatus in FIG. 7.

### DESCRIPTION OF EXAMPLE EMBODIMENTS

### Terms Description

Object—an object may be a person, a pet, a vehicle, a thing, an item, a device, a pillar, a furniture, or any matter that is stationery or in motion. An object can be living or non-living. In the case of a living or biological object such as a person and a pet, the object can be typically identified based on an appearance feature, a body part, a bodily characteristic, a motion of the object or a combination thereof. Examples of an appearance feature of an object (person) includes relative position, size, shape and/or contour of eyes, nose, cheekbones, jaw and chin, and also iris pattern, skin colour, hair colour or a combination thereof. A characteristic includes physical features such as height, body size, body shape, body ratio, length of limbs, hair colour, skin colour, apparel, belongings, other similar characteristics or combinations.

A motion includes behavioural characteristic such as body movement, position of limbs, direction of movement, moving speed, walking patterns, the way the object stands, moves or talks, change in physical features upon interaction with other objects, other similar characteristics or combinations. In the case of a non-living object, the object can be typically based on moving speed, moving characteristic/patterns and change in physical features upon interaction with other objects.

In various example embodiments below, an object may refer to one of the objects which have identified based on an appearance feature, a body part, a bodily characteristic, a motion of the object or a combination thereof from a video stream, i.e., target object, and one or more attributes of such target object is then detected and recognized from the video stream using an attribute detection module.

Video stream—a video stream refers to a continuous transmission or input of video or image files. The videos or images may be generated by a processor in connection with a video capturing device or retrieved from a database. In one example, the processor and the database may be in connection with a server. The transmission or input of video or image files may be through wired or wireless (e.g., via NFC communication, Wi-Fi communication, Bluetooth, etc.) or over a network (e.g., the Internet).

Hardware resource—a hardware resource refers to a processor unit or a memory, such as CPU, GPU or RAM, which is utilized by an attribute detection module or model stored in the memory to detect and one or more target attributes of an object that appears in a video stream generated by a video capturing apparatuses.

Attribute—an attribute in relation to an object refers to an action or an object class of the object.

Attribute detection module—an attribute detection module refers to a specific module in connection with a processor of an apparatus or server (e.g., attribute detection server) configured to run a model (e.g., neural network model) configured to perform a video analytic task/function such as action recognition or object classification and detect an attribute of an object from a video stream according to the configured video analytic task/function. When a video stream is processed through the attribute detection module, a video analytic result relating to the detection of the attribute in accordance with the pre-configured video analytic task/function of the model. Additionally, prior to the detection of the attribute, the attribute detection module, or a separate object detection module, may be utilized to detect the object appearing in a video stream based on such attribute or other attribute of the object. In the present disclosure, a certain video analytic task/function may be configured to process a video stream generated by a camera and the attribute detection module with the model configured to perform such configured video analytic task/function will be selected to process the video stream generated by the camera to generate the video analytic result.

In an example embodiment, there are multiple attribute detection modules each requiring different hardware resources to perform the video analytic tasks/functions to detect a specific or the same attribute of an object. In this present disclosure, the term “video analytic task” can be used interchangeably with the term “video analytic function”.

In the present disclosure, an attribute detection module which is tasked to run a model (e.g., neural network model) configured to perform action recognition task may be referred to as an action recognition module and the model run by it may be referred to as action recognition model. Similarly, an attribute detection module which is tasked to run a model (e.g., neural network model) configured to perform object classification task may be referred to as an object classification module and the model run by it may be referred to as object classification model. In an implementation, an attribute detection module may be tasked to run either or both models configured to perform action recognition task and object classification task.

Action—an action of an object may refer to a type of activity carried out by an object which can be recognized and classified from a video stream based on a sequence of physical features (e.g., appearance feature, body part, bodily characteristics) and/or motional/behaviour features (e.g., motions, movements) of the object identified from a video stream. Examples of an action includes sitting, talking, running, jumping, bicycle riding, fighting, stealing.

Object class—an object class in relation to an object refers to a class or category in which the object falls under based on an appearance feature, a body part, a bodily characteristic, a motion of the object or a combination. Examples of object classes includes, but not limited to, a person, an adult, a child, a non-living object, a device, a furniture, an animal, a person's belonging and an employee permitted to enter a premise.

Target attribute—a target attribute refers to an attribute that is of particular interest to be detected. In some example embodiments where the attribute that is of particular interest is an action (herein referred to as “target action”), the process of detecting the target attribute of an object that appears in a video stream includes a process of recognizing the target action of the object that appears in the video stream. In some other example embodiments where the attribute that is of particular interest is an object class (herein referred to as “target object class”), the process of detecting the target attribute of an object that appears in a video stream includes a process of identifying the target object class of the object that appears in the video stream or classifying the object that appears in the video stream to be of the target object class.

Interaction level—an interaction level in relation to an action correlates to a number of objects required in the relationship analysis for the action to be detected and recognized by an attribute detection module, which in turn correlates to an amount of hardware resources required by the attribute detection module to detect and recognize such action under the interaction level. In the present disclosure, an action involving two or less objects may be pre-configured as action of low interaction level; an action involving three objects may be pre-configured as action of medium interaction level; and an action involving four or more objects may be pre-configured as action of high interaction level. In the present disclosure, the term “interaction level” may be used interchangeably with “order interaction level” or “order level”.

For example, a bicycle riding action involves a person (object 1) and a bicycle (object 2) therefore it is pre-configured as low interaction level action, thus requiring lower amount of hardware resources to analyze and recognize the action; while gang fighting action may involve four or more persons therefore it is pre-configured as high interaction level action, and thus required higher amount of hardware resources to analyze and recognize the action. In some example embodiments, an interaction level may be associated with a video stream to indicate a corresponding amount of hardware resources is required to be allocated in order to process the video stream. This is typically the case if there is more than one action, which having a pre-configured interaction level, is detected from the video stream, and the highest interaction level among the interaction levels of the actions detected from the video stream is selected as the interaction level associated with the video stream, and as a result, the corresponding amount of hardware resources is then allocated to process the video stream so as to ensure the amount of hardware resources is adequate to detect all the object actions from the video stream.

Processing neural network layer—a processing neural network layer of an attribute detection module refers to a sub-module which, alone or in combination with one or more other neural network processing layers, is configured to generate a result or signal relating to a detection of a specific attribute of an object, in particular the object class of the object. Hereinafter, the term “processing neural network layer” may be used interchangeably with “processing layer” or “network layer”. Conventionally, processing layers which are specialized to identify different object classes are arranged in series and a video stream is processed through each processing layer (each combination of processing layers) to obtain a detection result or signal indicating whether the object can be classified under any of the object classes.

In one implementation, for object class which is easier to be detected and classified, for example, due to the distinct characteristic of the object class, a smaller number of processing layer may be required; whereas for object class which is harder to be detected and classified, a more processing layer may be required.

In an alternative implementation, processing layers which are specialized to identify an object class that of highest importance or relevance in the context of the application will be placed at the start of the series to ensure a detection result or signal relating the object of important or relevant object class can be generated first; whereas processing layers which are specialized to identify an object class that of lease importance or relevance in the context of the application will be placed at the end of the series.

The number of processing layer correlates to an amount of hardware resources required by the attribute detection module to detect and recognize such object classes. According to the present disclosure, where a detection of a specific target object class is indicated, the video stream will be processed up until the processing layers specialized to identify such target object class. This will minimize the hardware resources required to run the remaining processing layers in the series.

Indication—an indication may refer to a signal or information received from another connected device, server or processing unit. In one example embodiment, a user of an apparatus or system for detecting a target attribute of an object that appears in a video stream generated by a camera may input, select or indicate a target camera and the target attribute through the connected device or server, and such indication relating to a selection of a target camera and a task to detect the target attribute is then sent to the apparatus or system. Such communication may be facilitated by an application programming interface (“API”) which may be part of a user interface that may include graphical user (GUI), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof.

### Exemplary Example Embodiments

Example embodiments of the present disclosure will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “calculating”, “determining”, “updating”, “generating”, “initializing”, “outputting”, “retrieving”, “identifying”, “dispersing”, “authenticating” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system, Long Term Evolution (LTE) system and 5G mobile network system. The computer program when loaded and executed on such a computer effectively results in an apparatus that implements the steps of the preferred method.

Various example embodiments of the present disclosure relate to a method and an apparatus for recognizing an action of an object from a plurality of video streams. It is appreciated by a skilled person that such apparatus and the image capturing device may be implemented as part of a system to provide the same technical effect.

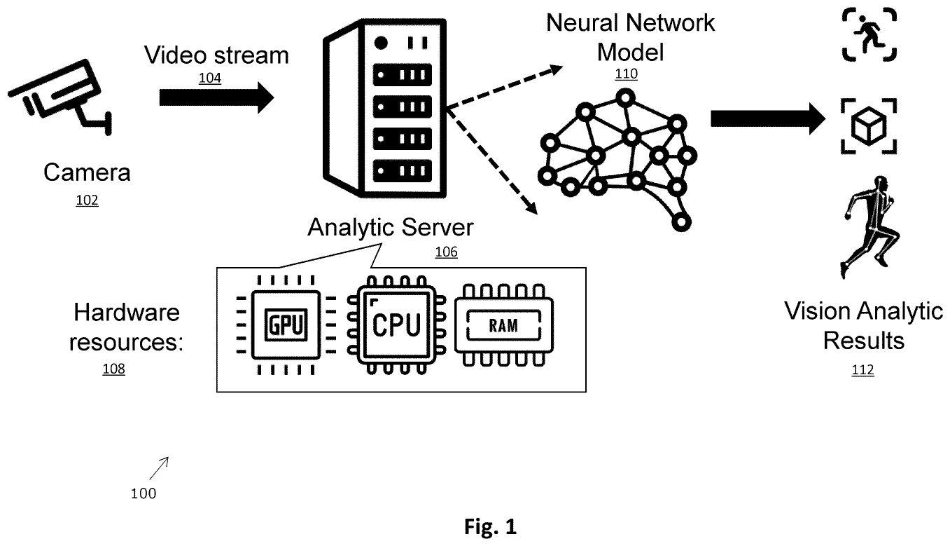

FIG. 1 shows a schematic diagram 100 illustrating an overview of a process for allocating hardware resources 108 to process video streams 104 generated by cameras 102. An analytic server 106 may pull out video streams 104 from the cameras 102 to process the video streams 104. In particular, the analytic server will use hardware resources 108 such as CPU, CPU and/or RAM to run the video streams 104 through neural network model 110 to perform video analytic tasks on the video streams 104 such as detecting objects and attributes, recognizing object actions and identifying object classes from the video streams 104, and then generate vision analytic results 112 for end-users.

If all the camera video streams are processed with the same neural network models to carrying out the same video analysis tasks/functions (e.g., only object classification or only action recognition), the different application requirements may not be satisfied or some hardware resources will be wasted; whereas, if all the camera video streams are processed with different neural network models to carrying different video analysis tasks/functions that recognizes/detects different set of target attributes, the deployment complexity will be significantly higher if the neural network models require different libraries/environments and thus hardware resources.

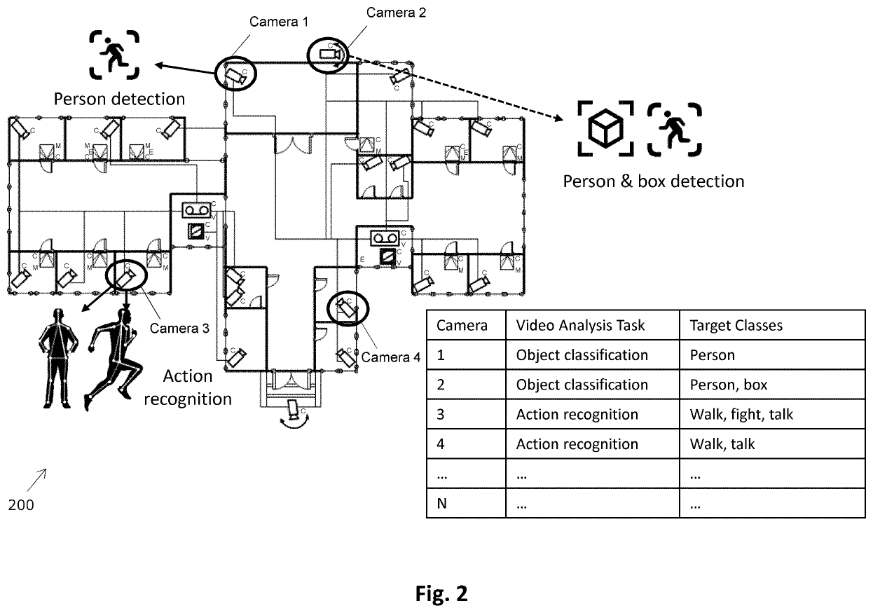

FIG. 2 shows a floor plan 200 of a premise where a video analytic system involving multiple cameras is deployed. The cameras are deployed in different locations of the premise. Each camera may be configured for a specific video analytic task. For example, Camera 1 is configured for object classification and the target attribute is object class “person”; Camera 2 is configured for object classification and the target attributes are object classes “person” and “box”; Camera 3 is configured for action recognition and the target attributes are actions “walk”, “fight” and “talk”; and Camera 4 is configured for action recognition and the target attributes are actions “walk” and “talk”. In such case, the analytic server (not shown) may pull the one or more video streams generated by each camera to perform the configured video analytic task by running the video stream through the corresponding attribute detection module (e.g., action recognition module for Camera 3 and Camera 4, and object classification module for Camera 1, Camera 2).

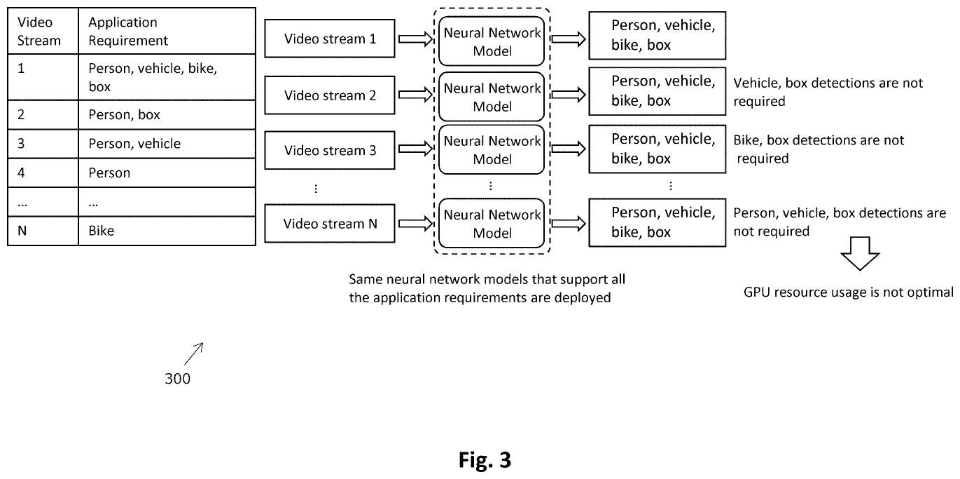

FIG. 3 shows a diagram 300 illustrating a process of conventional video analytic system to detect a target attribute of an object from each camera using a same neural network model. In this case, an analytic server receives video stream and runs a neural network model capable of performing object classifications to detect “Person”, “Vehicle”, “Bike” and “Box” object classes of objects that appear in a video stream. However, different video stream generated by different camera may have different object classification (application) requirement. In particular, the analytic server requires to detect “Person”, “Vehicle”, “Bike” and “Box” object classes of objects that appear in video stream 1 generated by Camera 1, “Person” and “Box” object classes of objects that appear in video stream 2 generated by Camera 2, “Person” and “Vehicle” object classes of objects that appear in video stream 3 generated by Camera 3, only “Person” object class of objects that appear in video stream 4 generated by Camera 4, and only “Bike” object class of objects that appear in video stream N generated by Camera N. In such case, deploying a same neural network capable of performing object classifications to detect “Person”, “Vehicle”, “Bike” and “Box” object classes of objects that appear in a video stream may optimize the GPU resource usage as Vehicle and box detections are not required in video stream 2, bike and box detections are not required in video stream 3, vehicle, bike and box are not required in video stream 4 and person, vehicle and box detections are not required in video stream N.

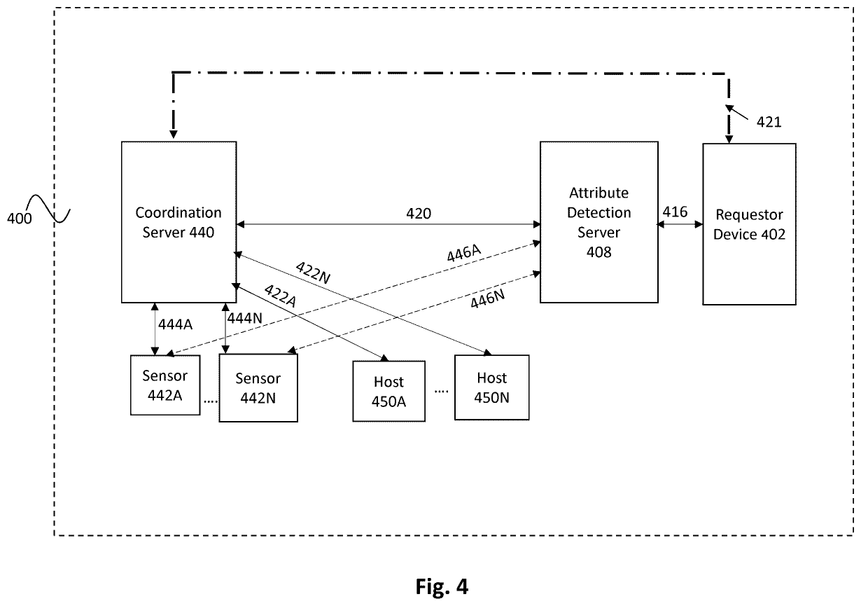

FIG. 4 illustrates a block diagram of a system 400 for allocating hardware resources to process a plurality of video streams generated by a plurality of video capturing apparatuses according to various example embodiments of the present disclosure.

The system 400 comprises a requestor device 402, an attribute detection server 408, a coordination server 440, hosts 450A to 450N, and sensors 442A to 442N.

The requestor device 402 is in communication with an attribute detection server 408 and/or a coordination server 440 via a connection 416 and 421, respectively.

The connection 416 and 421 may be wireless (e.g., via NFC communication, Wi-Fi communication, Bluetooth, etc.) or over a network (e.g., the Internet). The connection 416 and 421 may also be that of a network (e.g., the Internet).

The attribute detection server 408 is further in communication with the coordination server 440 via a connection 420. The connection 420 may be over a network (e.g., a local area network, a wide area network, the Internet, etc.). In one arrangement, the attribute detection server 408 and the coordination server 440 are combined and the connection 420 may be an interconnected bus.

The coordination server 440, in turn, is in communication with the hosts 450A to 450N via respective connections 422A to 422N. The connections 422A to 422N may be a network (e.g., the Internet).

The hosts 450A to 450N are servers. The term host is used herein to differentiate between the hosts 450A to 450N and the coordination server 440. The hosts 450A to 450N are collectively referred to herein as the hosts 450, while the host 450 refers to one of the hosts 450. The hosts 450 may be combined with the coordination server 440.

In an example, the host 450 may be one that is managed by a security officer of the entity and the coordination server 440 is a central server that coordinates the hosts 450 and decides which of the hosts 450 to forward data or retrieve data like image inputs.

Sensors 442A to 442N are connected to the coordination server 440 or the attribute detection server 408 via respective connections 444A to 444N or 446A to 446N. The sensors 442A to 442N are collectively referred to herein as the sensors 442. The connections 444A to 444N are collectively referred to herein as the connections 444, while the connection 444 refers to one of the connections 444. Similarly, the connections 446A to 446N are collectively referred to herein as the connections 446, while the connection 446 refers to one of the connections 446. The connections 444 and 446 may be wireless (e.g., via NFC communication, Wi-Fi communication, Bluetooth, etc.) or over a network (e.g., the Internet). The sensor 442 may be one of an image capturing device, object tracking device, video capturing device, motion sensor and temperature sensor, and may be configured to send an input depending its type, to at least one of the attribute detection server 408.

In the illustrative example embodiment, each of the devices 402 and 442; and the servers 408, 440, and 450 provides an interface to enable communication with other connected devices 402 and 442 and/or servers 408, 440, and 450. Such communication is facilitated by an application programming interface (“API”). Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof.

Use of the term ‘server’ herein can mean a single computing device comprising a processor or a plurality of interconnected computing devices which operate together to perform a particular function. That is, the server may be contained within a single hardware unit or be distributed among several or many different hardware units.

The coordination server 440

The coordination server 440 is associated with an entity (e.g. a company or organization or moderator of the service). In one arrangement, the coordination server 440 is owned and operated by the entity operating the server 408. In such an arrangement, the coordination server 440 may be implemented as a part (e.g., a computer program module, a computing device, etc.) of server 408.

The coordination server 440 may also be configured to manage the registration of users. A registered user has an action recognition account which includes details of the user. The registration step is called on-boarding. A user may use either the requestor device 402 or the host 450 to perform on-boarding to the coordination server 440.

It is not necessary to have an action recognition account at the coordination server 440 to access the functionalities of the coordination server 440. However, there are functions that are available to a registered user. For example, functions such as recognizing more complexed actions or an action involving multiple objects or increased maximum number of video streams input can be exclusive to registered users only.

The on-boarding process for a user is performed by the user through one of the requestor devices 402. In one arrangement, the user downloads an app (which includes the API to interact with the coordination server 440) to the sensor 442. In another arrangement, the user accesses a website (which includes the API to interact with the coordination server 440) on the requestor device 402.

Details of the registration include, for example, user identifier (ID) or appearance portrait of the user, address of the user, contact, or other important information and the sensor 442 that is authorized to update the action recognition account, and the like.

Once on-boarded, the user would have an action recognition account that stores all the details.

The requestor device 402

The requestor device 402 is associated with a subject (or requestor) who is a party to an attribute detection request that starts at the requestor device 402. The requestor may be a concerned member of the public or a security officer of an entity who is assisting to get data necessary to detect and recognize a target attribute (e.g., stealing action, fighting action, animal class, person class) of an object within the entity. The requestor device 402 may be a computing device such as a desktop computer, an interactive voice response (IVR) system, a smartphone, a laptop computer, a personal digital assistant computer (PDA), a mobile computer, a tablet computer, and the like.

In one example arrangement, the requestor device 402 is a computing device in a watch or similar wearable and is fitted with a wireless communications interface.

The attribute detection server 408

The attribute detection server 408 is as described above in the “terms” description section, and is configured to run a model (e.g., neural network model) configured to perform a video analytic task/function such as action recognition or object classification and detect an attribute of an object from a video stream received from a sensor 442 according to the configured video analytic task/function.

The hosts 450

The host 450 is a server associated with an entity (e.g. a company or organization) which manages (e.g. establishes, administers) object information relating to an object which/whose attribute is detected.

In one arrangement, the entity is a bank. Therefore, each entity operates a host 450 to manage the resources by that entity. In one arrangement, a host 450 receives an alert signal that a target action is detected. The host 450 may then arrange to send resources to the location identified by the location or camera information included in the alert signal. For example, the host may be one that is configured to obtain relevant video or image input for processing.

In one arrangement, the video stream, the object and attributes detected may be stored and updated on the attribute detection account associated with the user. Advantageously, such information is valuable to the law enforcement and the user such as security or building management staff who does object identification, tracking and monitoring. It reduces number of hours looking through camera footage to detect a target attribute of an object from multiple video streams generated by multiple sensors 442.

### Sensor 442

The sensor 442 is associated with a user associated with the requestor device 402. The sensor 442 may be one of an image capturing device, object tracking device, video capturing device, motion sensor and temperature sensor, and may be configured to generate a video stream or video file, to at least one of the attribute detection server 408 for detecting a target attribute of an object from the video stream. The sensor 442 may also be configured to send information relating to the sensor or the video stream which it generates (e.g., location, resolution) to coordination server 440 for allocation of hardware resources to process the video steams generated by the sensor 442.

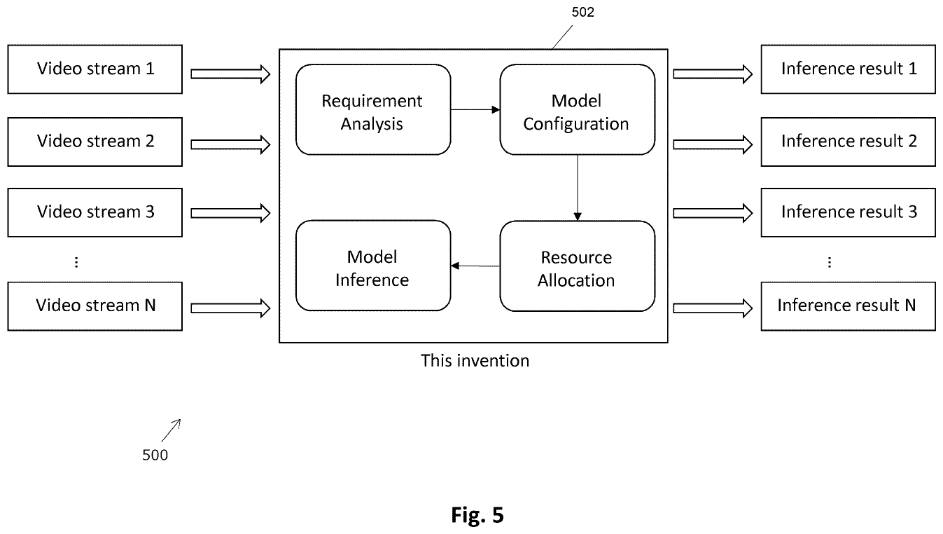

FIG. 5 shows a diagram illustrating a process for detecting a target attribute of an object from multiple video streams generated by multiple cameras. The video streams may be sent to a server or module 502 to be processed to generated respective video analytic results. The module 502 comprises a Requirement Analysis unit, a Model Configuration unit, a Resource Allocation unit and a Model Inference unit. The Requirement Analysis unit is configured to collect and analyze the application requirement information of different camera streams, including the vision/video analytic task, action/class list, and other possible requirements. The output of the requirement analysis unit is an attribute detection model type (e.g., action recognition model, or object classification model), an order level in case of action recognition and a number of network layers in case of object classification model.

The Model Configuration unit configures the neural network model setting (e.g., order interaction level or number of neural network layers) based on the requirement analysis results from the Requirement Analysis unit. In particular, the Model Configuration unit receives an indication of the model type, order level or network layers of each video stream from the Requirement Analysis unit and select the neural network model configured the required tasks and set the order level/network for inference and processing the video stream. The Resource Allocation unit is then configured to allocate the hardware resources based on the model configuration results to minimize the hardware resource consumption while satisfying the application requirements. The Model Inference unit then predict the results (e.g., detection results of action recognition or object classification) with the video stream input, configured neural network model and allocated hardware resources.

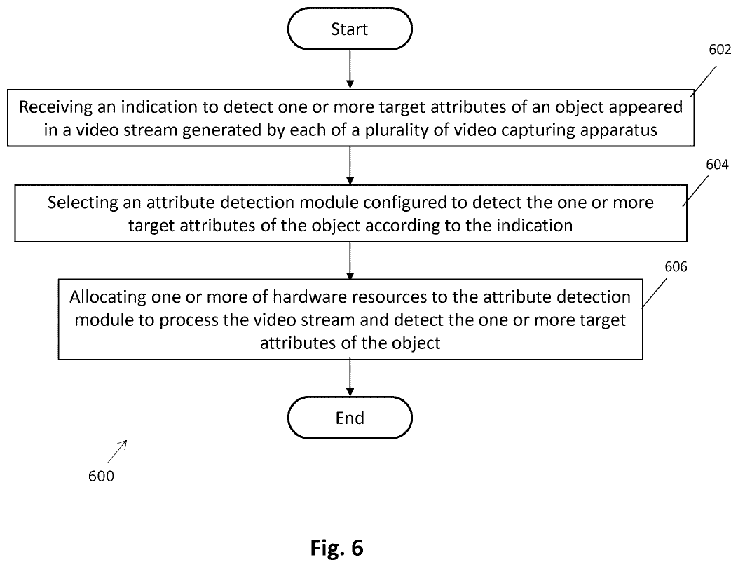

FIG. 6 shows a flowchart illustrating a process for allocating hardware resources to process a plurality of video streams generated by a plurality of video capturing apparatuses according to various example embodiments of the present disclosure.

In step 602, an indication to detect one or more target attributes of an object that appears in a video stream generated by each of the plurality of video capturing apparatuses is received. In step 604, an attribute detection module configured to detect the one or more target attributes of the object according to the indication is selected. In step 606, one or more of the hardware resources is allocated to the attribute detection module to process the video stream and detect the one or more target attributes of the object.

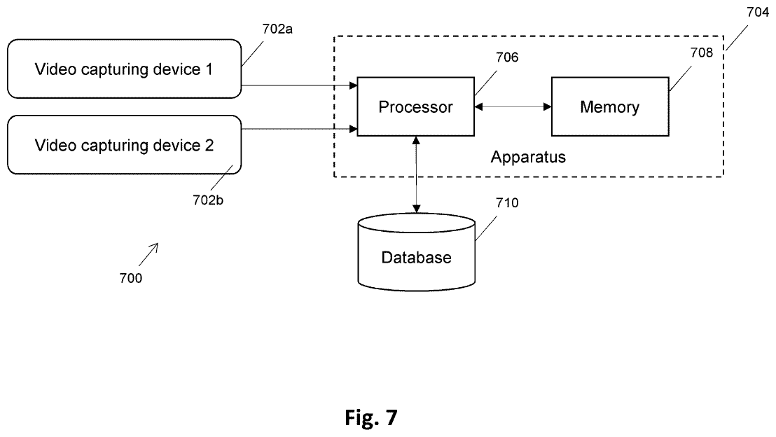

FIG. 7 shows a block diagram illustrating a system 700 for recognizing an action of an object from a first plurality of video streams according to various example embodiments of the present disclosure.

In an example, the managing of image input and signal input is performed by every video capturing device 702a, 702b. The system 700 comprises video capturing devices 702a, 702b (for the sake of simplicity, only two video capturing devices are illustrated) in communication with an apparatus 704. In an implementation, the apparatus 704 may be generally described as a physical device comprising at least one processor 706 and at least one memory 708 including computer program code. The at least one memory 708 and the computer program code are configured to, with the at least one processor 706, cause the physical device to perform the operations described in FIG. 6. The processor 706 is configured to receive a first plurality of video streams from the video capturing devices 706a, 706b or retrieve the first plurality of video streams from a database 710. Alternatively or additionally, the first plurality of video streams captured by the video capturing devices 702a, 702b are stored in a database 710, and the host processor 706 is configured to retrieve first plurality of video streams from the database 710.

The video capturing devices 702a, 702b are collectively referred to herein as the video capturing device 702, while the video capturing device 702 refers to one of the hosts 702. The video capturing device 702 may be a device such as a closed-circuit television (CCTV) which provides a variety of data (camera data) of which physical, motional/behaviour and object feature data that can be used by the system to detect an object as well as to detect a target attribute of the object. In an implementation, the data derived from the video capturing device 702 may be stored in memory 708 of the apparatus 704 or a database 710 accessible by the apparatus 704.

Additionally, camera data such as location data relating to a location at which the camera is fixated or capturing, time data such as timestamp of the video/image may be received, stored and/or retrieved to derive location and timestamp of an action relating to an object for recognizing an action of the object.

According to the present disclosure, the apparatus 704 may be configured to communicate with the video capturing device 702, the database 710 and multiple processing units (not shown). In one implementation, the processing units can be part of the apparatus 704 and are communicated with the processor 708. Similarly, in one implementation, the database 710 can be part of the apparatus 704.

The apparatus 704 may receive from the video capturing devices 702, or retrieve from the database 710, a plurality of video streams as input. The apparatus 704 may receive an indication to detect one or more target attributes of an object that appears in a video stream generated by the video capturing device 702.

The memory 706 and the computer program code stored therein are configured to, with the processor 706 cause the apparatus to select an attribute detection module (not shown) configured to detect the one or more target attributes of the object according to the indication and allocate one or more hardware resources (e.g., a part of the memory 708 or a processing unit of the processor 706) to the attribute detection module to process the video stream and detect the one or more target attributes of the object. The attribute detection module can be part of the apparatus 704.

In one example embodiment, the apparatus 704 may receive a first input relating to a selection of the each of the plurality of video capturing apparatuses; and a second input relating to a selection of a task to detect the one or more target attributes of the object. The memory 706 and the computer program code stored therein are configured to, with the processor 706 cause the apparatus to select the attribute detection module based on the first and second input.

In one example embodiment, wherein one or more target attributes are all target actions and thus an indication to detect the target actions of an object that appears in a video stream generated by one of the video capturing devices 702 is received, the memory 706 and the computer program code stored therein are configured to, with the processor 706 cause the apparatus to select an attribute detection module (e.g., action recognition module) configured to detect such target actions and allocate the hardware resources required by such attribute detection module to perform the action recognition task and detection of the target actions.

Additionally, where each target action is associated with a pre-configured interaction level and a high pre-configured interaction level of an action indicates more hardware resources are required by the attribute detection module to detect the action, the memory 706 and the computer program code stored therein are configured to, with the processor 706 cause the apparatus to identify an interaction level associated with the video stream based on the pre-configured object interaction levels corresponding to the target actions. The memory 706 and the computer program code stored therein are configured to, with the processor 706 cause the apparatus to select the attribute detection module (e.g., action recognition module) configured to detect such target actions and allocate the hardware resources required by such attribute detection module to perform the action recognition task and detection of the target actions based on the interaction level associated with the video stream. A list of target actions and their corresponding pre-configured interaction levels may be stored in the memory 706 or database 710, and the apparatus 704 is configured to retrieve the pre-configured interaction levels of the target actions from the memory 706 or database 710.

Where there are two target actions to be detected with two different pre-configured interaction levels, the memory 706 and the computer program code stored therein are configured to, with the processor 706 cause the apparatus to select a higher (or highest) pre-configured interaction level among the two pre-configured interaction levels as the interaction level associated with the video stream.

In an alternative example embodiment, wherein the one or more target attributes are all target object classes and thus an indication to detect the target object classes of an object that appears in a video stream generated by one of the video capturing devices 702 is received, the memory 706 and the computer program code stored therein are configured to, with the processor 706 cause the apparatus to select an attribute detection module (e.g., object classification module) and allocate the hardware resources required by such attribute detection module to perform the object classification task and detection of the target object classes. A list of target object class and their corresponding pre-configured number of processing layers required may be stored in the memory 706 or database 710, and the apparatus 704 is configured to retrieve the pre-configured number of processing layers of the target object classes from the memory 706 or database 710.

Additionally, the memory 706 and the computer program code stored therein are configured to, with the processor 706 cause the apparatus to identify a number of processing neural network layers of the attribute detection module required to process the video stream based on a pre-configured number of processing layers required to detect each of the one or more target object classes, and the memory 706 and the computer program code stored therein are configured to, with the processor 706 cause the apparatus to select the attribute detection module (e.g., action recognition module) configured to allocate the one or more of the hardware resources required by such attribute detection module to run the second video stream through the number of processing neural network layers to detect the one or more target object classes from the video stream.

Where there are two target objects to be detected with two different pre-configured number of processing neural network layers, the memory 706 and the computer program code stored therein are configured to, with the processor 706 cause the apparatus to select a higher (or highest) number of processing layers among the two different pre-configured number of processing neural network layers as the number of processing layers associated with the video stream.

The memory 708 and the computer program code stored therein are configured to, with the processor 706 cause the apparatus 704 to generate a result of the detection of the one or more target attributes of the object from the plurality of video streams using the one or more hardware resources allocated to each of the video capturing apparatus 702.

In the following paragraphs, a first example embodiment, where action recognition video analytic tasks are set to be perform on a video stream received from one of multiple cameras, is described.

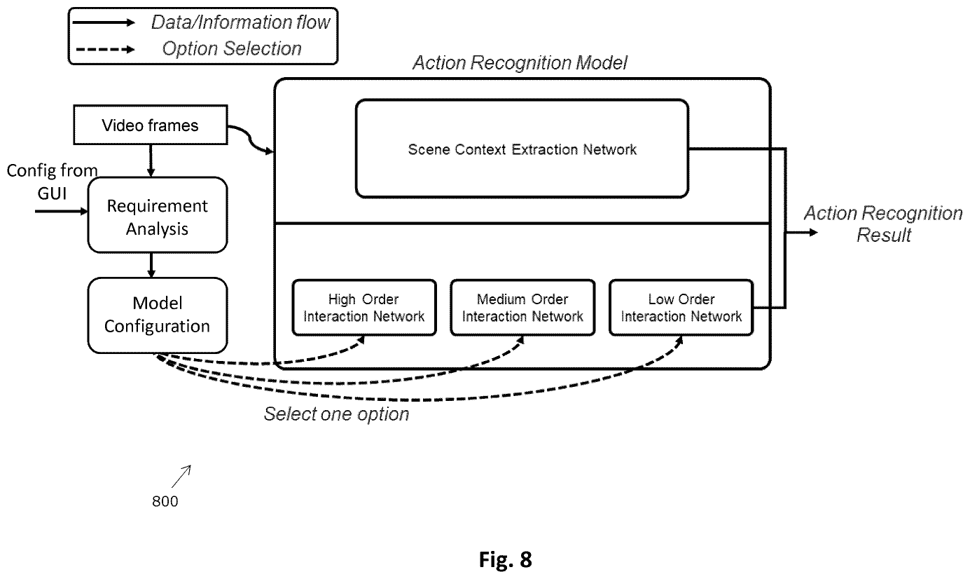

FIG. 8 shows a diagram 800 illustrating a process for detecting a target action of an object from a video stream generated by a camera according to the first example embodiment of the present disclosure. An indication through API which may be part of a user interface that may include graphical user interfaces (GUIs), Web-based interfaces, programmatic interfaces and messaging interface may be received by a Requirement Analysis unit from another connected devices (not shown) to indicate the video analytic requirement to detect such target action (i.e., perform action recognition of such target action) from the video stream. The video stream comprising multiple video frames are passed to a Scene Context Extraction Network module of an Action Recognition module to obtain the context information on action recognition. A Model Configuration unit then selects a High

Order Interaction Network module, Medium Order Interaction Network module or Low Order Interaction Network module of the Action Recognition module based on the video analytic requirement and the context information, for example, based on the pre-configured interaction level of the target action. Each Order Interaction Network module may be configured to detect and recognize actions of different order interaction levels, and thus requires different hardware resources to operate and perform the video analytic task. The video frames are then processed by the selected Order Interaction Network module to generate an action recognition result.

An order interaction analyses the relationships between the detected objects. A higher order interactions or higher order interaction levels indicates that more objects are involved in the relationship analysis such as action recognition. For example, an action of higher order interaction level indicates that more objects (or more movements of the objects) are required in the analysis, and thus generally requires more powerful module (e.g., high order interaction network module) with more hardware resources to analyze the relationship between objects and recognize the action carried out by the objects as compared to that of lower order interaction level.

Generally, a High Order Interaction Network module requires most hardware resources to operate and are used to perform video analytic tasks on actions of high interaction level, while a Low Order Interaction Network module requires the least hardware resources to operate and are used to perform video analytic tasks on actions of lower interaction level. Deploying a High Order Interaction Network module to analyze actions of lower interaction level may result in wastage of hardware resources which could have been put into better use for other purpose; whereas a Low Order Interaction Network module may not be powerful enough to detect target actions of high interaction level and does not satisfy the video analytic requirement.

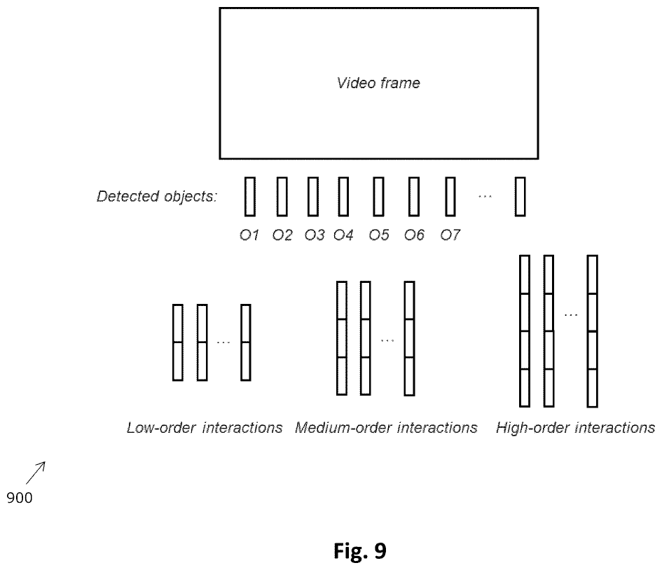

FIG. 9 shows a diagram 900 illustrating three different order interaction levels according to an example embodiment. Multiple objects (01, 02, 03, 04, 05, 06, 07, . . . ) are detected from the video frame. In one implementation, an action involving two or less objects may be pre-configured as action of low interaction level; an action involving three objects may be pre-configured as action of medium interaction level; and an action involving four or more objects may be pre-configured as action of high interaction level. If an indication to detect a target action of an object is received and the target action involves three objects only (medium interaction level), a Medium Order Interaction Network module may be deployed to process the video stream and detect the target action of medium interaction level such that the selected module and allocated hardware resources to process the video stream can be optimized.

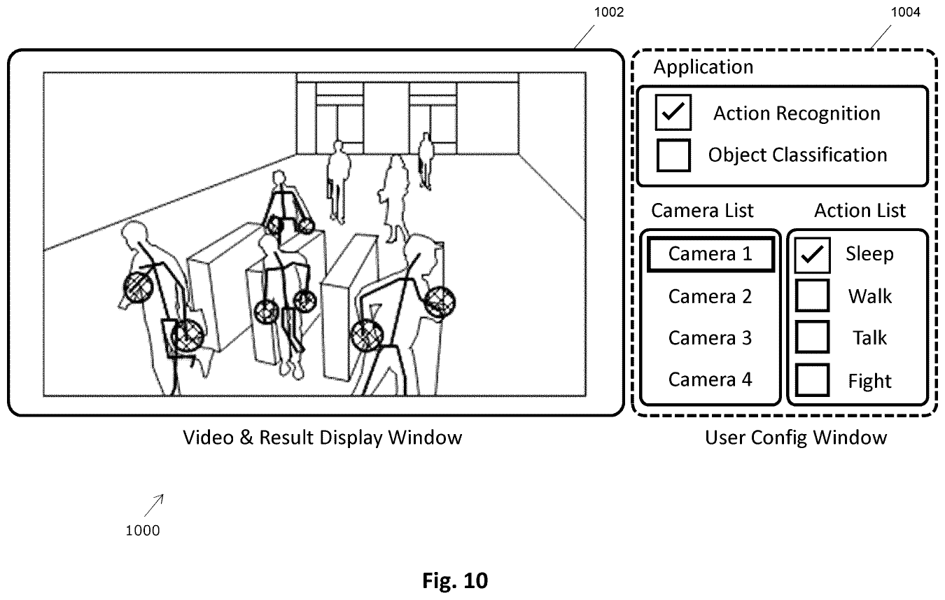

FIG. 10 shows a diagram 1000 illustrating an example graphical user interface according to the first example embodiment of the present disclosure. In this example, the video stream is shown on a display window 1002. In a configuration panel 1004, a list of cameras (Cameras 1-4) is shown. In this case, an input relating to a selection of a target camera, Camera 1, is received. Subsequently, the available two video analytic tasks, Action Recognition task and Object Classification task, for processing the video stream of the target camera is shown in the configuration panel 1004. In this case, an input relating to a selection of the Action Recognition task is received. A list of target actions is shown in response to the input relating to the section of the Action Recognition task. In this case, the target actions list comprising four different target actions, “Sleep”, “Walk”, “Talk” and “Fight” is shown. Subsequently, an input relating to a selection of a target action “Sleep” from the list of target actions is then received. Collectively, the inputs from the GUI operations indicates that the analytic server (not shown) is configured to perform an action recognition task to detect “Sleep” action of objects that appear in the video stream generated by the target camera, Camera 1. Descriptions relating to each input option may be shown on the bottom of the GUI to facilitate user operations and selections.

Table 1 shows estimated corresponding hardware resources (GPU memory) required by an attribute detection module to detect target actions of different pre-configured order levels of different target actions and their according to an example embodiment of the present disclosure.

TABLE 1

| Action | Pre-configured Order Level | Estimated GPU memory |
|---|---|---|
| Sleep | Low | 2 GB |
| Walk | Low | 2 GB |
| Talk | Medium | 4 GB |
| Fight | High | 6 GB |
| Suicide | Low | 2 GB |

In this example embodiment, where sleep, walk and suicide actions require two or less objects involved in the relationship analysis, they are pre-configured as low order level actions, and a Low-Order Network module and an estimated 2 GB GPU memory may be required to detect such action. Where talk action may require three objects (e.g., two faces, hand) in the relationship analysis it is pre-configured as medium order level action, and a Medium-Order Network module and an estimated 4 GB GPU memory may be needed to detect talk action. Where fight action may involve more than four or more objects (e.g., four persons) in the relationship analysis, it is pre-configured as high order level action, and a High-Order Network module and an estimated 6 GB GPU memory are needed to detect fight action.

Table 2 shows allocated hardware resources to process video streams with different indications to detect different target actions of an object according to an example embodiment of the present disclosure.

TABLE 2

| | | | Assigned |
|---|---|---|---|
| Video Stream | Target Actions | Order level | GPU Memory |
| 1 | Sleep, Walk | Low | 2 GB |
| 2 | Talk | Medium | 2 GB |
| 3 | Suicide | Low | 4 GB |
| 4 | Fight, Suicide | High | 6 GB |

In this example embodiment, indications to detect sleep and walk actions from video stream 1, talk action from video stream 2, suicide action from video stream 3 and fight and suicide actions from video stream 4 are received. Based on Table 1, as both sleep and walk actions are low order level actions, video stream 1 is then associated with a low order level. A Low-Order Network module is selected and 2 GB GPU memory is assigned to process video stream 1 to detect sleep and walk actions of objects that appear in video stream 1. Talk action is a medium order level action, therefore video stream 2 is associated with a medium order level. A Medium-Order Network module is selected and 4 GB GPU memory is assigned to process video stream 2 to detect talk actions of objects that appear in video stream 2. Suicide action is low order level action, therefore video stream 3 is also associated with a low order level. A Low-Order Network module is selected and 2 GB GPU memory is assigned to process video stream 3 to detect suicide actions of objects that appear in video stream 3. Suicide is a low order level action but fight is a high order level action. In this case, as two actions with different pre-configured order levels are indicated, the higher among the two, i.e., high order level is selected as the order level of video stream 4. A High-Order Network module is selected and 6 GB GPU memory is assigned to process video stream 4 to detect both suicide and fight actions of objects that appear in video stream 4.

It is noted that, in a conventional method, a same module with 6 GB GPU memory will be used to process the video stream to detect each target action.

In the following paragraphs, a second example embodiment, where object classification video analytic tasks are set to be perform on a video stream received from one of multiple cameras, is described.

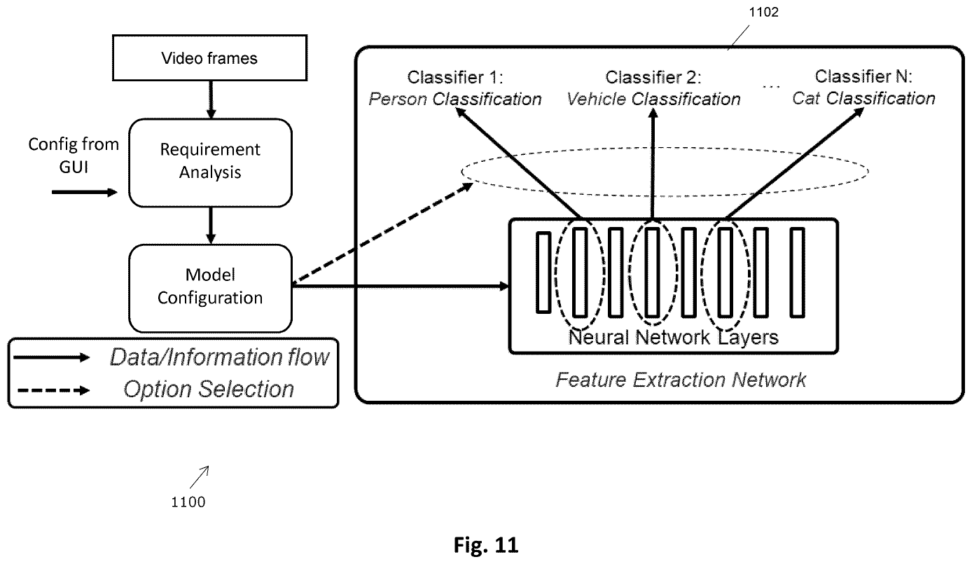

FIG. 11 shows a diagram illustrating a process for detecting a target action of an object from a video stream generated by a camera according to the second example embodiment of the present disclosure. An object classification module 1102 comprises a plurality of neural network layers arranged in series.

Each neural network layer may generate an object classification result relating to a specific object class and therefore be used as a classifier to detect the specific object class from a video frame when running the video frame through the neural network layer. In some implementations, the result of two or more neural networks may be combined as a classifier to generate an object classification result relating to the specific object class. Different combinations of neural network layers may be used as different classifiers for classifying different object classes and are arranged in series such that when a video frame may be passed through all the different classifiers for classifying different object classes from the video frame.

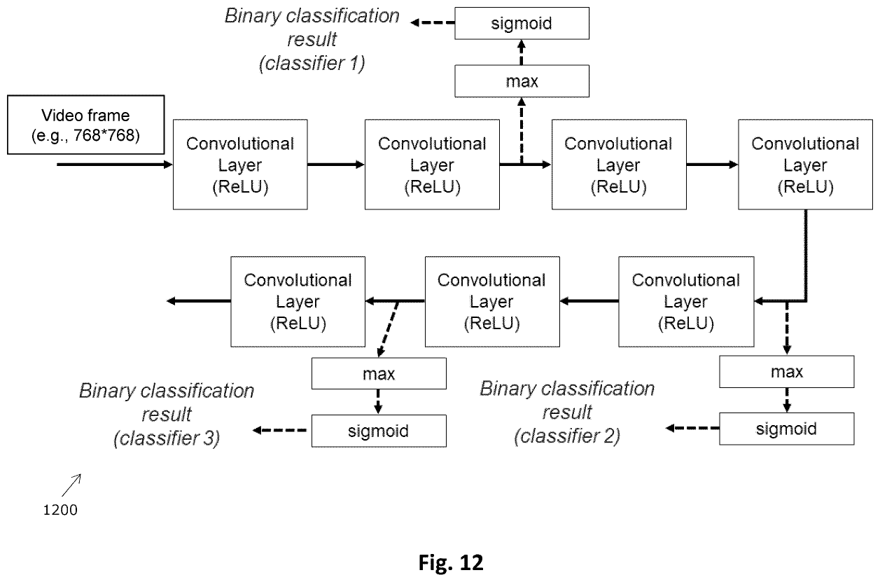

FIG. 12 shows a diagram 1200 illustrating neural network layers according to an example embodiment of the present disclosure. The input video frame is in the resolution of 768*768 and there are seven convolutional layers each with

Rectified Linear (ReLU) function arranged in a series. The video frame may be passed through the seven convolution layers to obtain different binary classification results for classifying different object classes. In particular, the video frame may be passed through the first two convolution layers and obtain a first binary classification result with max and sigmoid activations for use as a first classifier to detect a first class (e.g., person) of an object that appears in the video frame. The video frame may be then passed through the next two convolution layers to obtain a second binary classification result with max and sigmoid activations for use as a second classifier to detect a second class (e.g., vehicle) of an object that appears in the video frame. The video may be then passed through the next two convolution layers to obtain a third binary classification result with max and sigmoid activations for use as a third classifier to detect a third class (e.g., cat) of an object that appears in the video frame.

Returning to FIG. 11, an indication through API which may be part of a user interface that may include graphical user interfaces (GUIs), Web-based interfaces, programmatic interfaces and messaging interface may be received by a Requirement Analysis unit from another connected devices (not shown) to indicate the video analytic requirement to detect such target object class (i.e., perform object classification of such target object class) from the video stream. A Model Configuration unit selects a number of neural network layers within an attribute detection module 1102 that are required to perform a classification of the target object class based on the video analytic requirement, for example, based on the pre-configured number of processing layers of the target object class.

For example, the first and second neural network layers are pre-configured to be used a classifier for person classification; the third and fourth neural network layers are pre-configured to be used as another classifier for vehicle classification; and the fifth and sixth neural network layers are pre-configured to be used as a yet another classifier for cat classification. If an indication to detect a vehicle object class from the video stream is received, the Model Configuration unit will then select four neural network layers such that the video frames are run until the fourth neural network layers to generate a classification result relating to vehicle object class. In practical system deployment, the selection of different layers is implemented in the inference program to set the number of layers that the image data needs to pass through for final output.

Generally, processing video frames through more neural network layers requires more hardware resources. Deploying higher number of neural networks and classifiers to detect multiple object classes may result in wastage of hardware resources which could have be put into better use for other purpose while deploying too few neural networks may not be failure to detect target object class and satisfy the video analytic requirement.

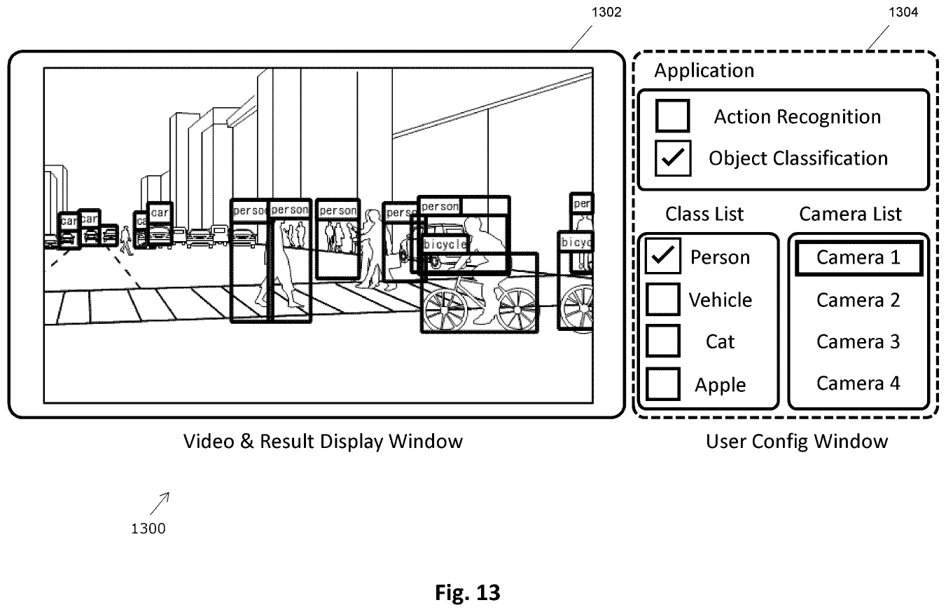

FIG. 13 shows a diagram 1300 illustrating an example graphical user interface according to the second example embodiment of the present disclosure. In this example, the video stream is shown on a display window 1302. In a configuration panel 1304, a list of cameras (Cameras 1-4) is shown. In this case, an input relating to a selection of a target camera, Camera 1, is received. Subsequently, the available two video analytic tasks, Action Recognition task and Object Classification task, for processing the video stream of the target camera are shown in the configuration panel 1304. In this case, an input relating to a selection of the Object Classification task is received. A list of target actions is shown in response to the input relating to the section of the Object Classification task. In this case, the target actions list comprising four different target object classes, “Person”, “Vehicle”, “Cat” and “Apple” is shown. Subsequently, an input relating to a selection of a target action “Person” from the list of target actions is then received. Collectively, the inputs from the GUI operations indicates that the analytic server (not shown) is configured to perform an object classification task to detect “Person” class of objects that appear in the video stream generated by the target camera, Camera 1. Descriptions relating to each input option may be shown on the bottom of the GUI to facilitate user operations and selections.

Table 3 shows estimated corresponding hardware resources (GPU memory) required by an attribute detection module to detect different target object classes according to an example embodiment of the present disclosure.

TABLE 3

| | Pre-configured number | Estimated | |
|---|---|---|---|
| Object class | of Network Layers | GPU memory | |
| Box | 3 | 1 | GB |
| Person | 4 | 2 | GB |
| Vehicle | 4 | 2 | GB |
| Cat | 2 | 0.5 | GB |
| Bicycle | 3 | 1 | GB |

In this example embodiment, each of different object classes has a pre-configured number of network layers required in order to be detected. In particular, two neural network layers with an estimated of 0.5 GB GPU memory are required to generate a cat detection result; three neural network layers with an estimated of 1 GB GPU memory are required to generate box or bicycle detection result; and the four neural network layers with an estimated of 2 GB GPU memory are required to generate a person and bicycle detection result.

Table 4 shows allocated hardware resources to process video streams with different indications to detect different target object classes of an object according to an example embodiment of the present disclosure.

TABLE 4

| | Target Object | Number of | Assigned GPU |
|---|---|---|---|
| Video Stream | Class | Network Layers | Memory |
| 1 | Box, Person | 4 | 2 GB |
| 2 | Box, Cat | 3 | 1 GB |
| 3 | Cat, Bicycle | 3 | 1 GB |
| 4 | Person, Vehicle | 4 | 2 GB |

In this example embodiment, indications to detect box and person object classes from video stream 1, box and cat object classes from video stream 2, cat and bicycle object classes from video stream 3 and person and vehicle object classes from video stream 4 are received. Based on Table 3, box and person can be detected using three and four network layers, therefore, video stream 1 is associated with four network layers, i.e., the higher among the two pre-configured number of network layers, with 2 GB GPU memory. Box and cat can be detected using three and two network layers, respectively, therefore, video stream 2 is associated with three network layers, i.e., the higher among the two pre-configured number of network layers, with 1 GB GPU memory. Cat and bicycle can be detected using two and three network layers, respectively, therefore, video stream 3 is associated with three network layers, i.e., the higher among the two pre-configured number of network layers, with 1 GB GPU memory. Person and vehicle both can be detected using four network layers, therefore, video stream 4 is associated with four network layers, with 2 GB GPU memory.

It is noted that, in a conventional method, a same module will be used to process the video stream through all network layers (e.g., 7 layers using 4 GB GPU memory) to detect each target object class.

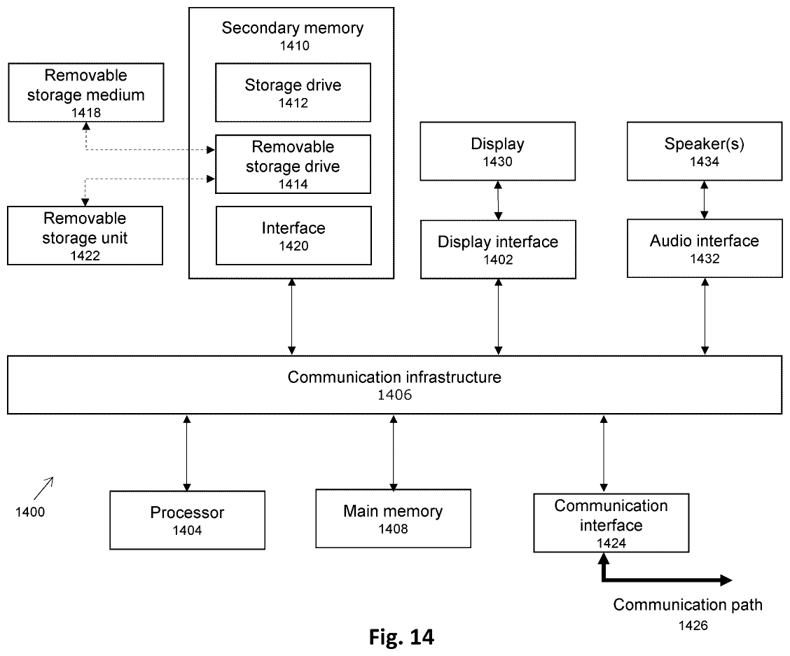

FIG. 14 shows a schematic diagram of an exemplary computing device 1400, hereinafter interchangeably referred to as a computer system 1400, where one or more such computing device 1400 may be used or suitable for use to execute the method in FIG. 6 and implement the apparatus in FIG. 7. The following description of the computing device 1400 is provided by way of example only and is not intended to be limiting.

As shown in FIG. 14, the example computing device 1400 includes a processor 1404 for executing software routines. Although a single processor is shown for the sake of clarity, the computing device 1400 may also include a multi-processor system. The processor 1404 is connected to a communication infrastructure 1406 for communication with other components of the computing device 1400. The communication infrastructure 1406 may include, for example, a communications bus, cross-bar, or network.

The computing device 1400 further includes a main memory 1408, such as a random access memory (RAM), and a secondary memory 1410. The secondary memory 1410 may include, for example, a storage drive 1412, which may be a hard disk drive, a solid state drive or a hybrid drive and/or a removable storage drive 1414, which may include a magnetic tape drive, an optical disk drive, a solid state storage drive (such as a USB flash drive, a flash memory device, a solid state drive or a memory card), or the like. The removable storage drive 1414 reads from and/or writes to a removable storage medium 1418 in a well-known manner. The removable storage medium 1418 may include magnetic tape, optical disk, non-volatile memory storage medium, or the like, which is read by and written to by removable storage drive 1414. As will be appreciated by persons skilled in the relevant arts, the removable storage medium 1418 includes a computer readable storage medium having stored therein computer executable program code instructions and/or data.

In an alternative implementation, the secondary memory 1410 may additionally or alternatively include other similar means for allowing computer programs or other instructions to be loaded into the computing device 1400. Such means can include, for example, a removable storage unit 1422 and an interface 1420. Examples of a removable storage unit 1422 and interface 1420 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 1422 and interfaces 1420 which allow software and data to be transferred from the removable storage unit 1422 to the computer system 1400.

The computing device 1400 also includes at least one communication interface 1424. The communication interface 1424 allows software and data to be transferred between computing device 1400 and external devices via a communication path 1426. In various example embodiments of the disclosure, the communication interface 1424 permits data to be transferred between the computing device 1400 and a data communication network, such as a public data or private data communication network. The communication interface 1424 may be used to exchange data between different computing devices 1400 which such computing devices 1400 form part an interconnected computer network. Examples of a communication interface 1424 can include a modem, a network interface (such as an Ethernet card), a communication port (such as a serial, parallel, printer, GPIB, IEEE 1394, RJ45, USB), an antenna with associated circuitry and the like. The communication interface 1424 may be wired or may be wireless. Software and data transferred via the communication interface 1424 are in the form of signals which can be electronic, electromagnetic, optical or other signals capable of being received by communication interface 1424. These signals are provided to the communication interface via the communication path 1426.

As shown in FIG. 14, the computing device 1400 further includes a display interface 1402 which performs operations for rendering images to an associated display 1430 and an audio interface 1432 for performing operations for playing audio content via one or more associated speakers 1434.

As used herein, the term “computer program product” may refer, in part, to removable storage medium 1418, removable storage unit 1422, a hard disk installed in storage drive 1412, or a carrier wave carrying software over communication path 1426 (wireless link or cable) to communication interface 1424. Computer readable storage media refers to any non-transitory, non-volatile tangible storage medium that provides recorded instructions and/or data to the computing device 1400 for execution and/or processing. Examples of such storage media include magnetic tape, CD-ROM, DVD, Blu-ray Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 1400. Examples of transitory or non-tangible computer readable transmission media that may also participate in the provision of software, application programs, instructions and/or data to the computing device 1400 include radio or infra-red transmission channels as well as a network connection to another computer or networked device, and the Internet or Intranets including e-mail transmissions and information recorded on Websites and the like.

The computer programs (also called computer program code) are stored in main memory 1408 and/or secondary memory 1410. Computer programs can also be received via the communication interface 1424. Such computer programs, when executed, enable the computing device 1400 to perform one or more features of example embodiments discussed herein. In various example embodiments, the computer programs, when executed, enable the processor 1404 to perform features of the above-described example embodiments. Accordingly, such computer programs represent controllers of the computer system 1400.

Software may be stored in a computer program product and loaded into the computing device 1400 using the removable storage drive 1414, the storage drive 1412, or the interface 1420. The computer program product may be a non-transitory computer readable medium. Alternatively, the computer program product may be downloaded to the computer system 1400 over the communications path 1426. The software, when executed by the processor 1404, causes the computing device 1400 to perform the necessary operations to execute the method in FIG. 6 and implement the apparatus in FIG. 7.

It is to be understood that the example embodiment of FIG. 14 is presented merely by way of example to explain the operation and structure of the apparatus. Therefore, in some example embodiments one or more features of the computing device 1400 may be omitted. Also, in some example embodiments, one or more features of the computing device 1400 may be combined together. Additionally, in some example embodiments, one or more features of the computing device 1400 may be split into one or more component parts.

It will be appreciated by a person skilled in the art that numerous variations and/or modifications may be made to the present disclosure as shown in the specific example embodiments without departing from the spirit or scope of the disclosure as broadly described. The present example embodiments are, therefore, to be considered in all respects to be illustrative and not restrictive.

This application is based upon and claims the benefit of priority from Singapore patent application Ser. No. 10/202,300627Q, filed on Mar. 8, 2023, the disclosure of which is incorporated herein in its entirety by reference.

For example, the whole or part of the exemplary example embodiments disclosed above can be described as, but not limited to, the following supplementary notes.

### (Supplementary Note 1)

A method of allocating hardware resources to process a plurality of video streams generated by a plurality of video capturing apparatuses, the method comprising:
receiving an indication to configure each of the plurality of video capturing apparatuses to detect one or more target attributes of an object that appears in a video stream generated by the corresponding video capturing apparatus;
selecting an attribute detection module configured to detect the one or more target attributes of the object according to the indication; and
allocating one or more of the hardware resources to the attribute detection module to process the video stream and detect the one or more target attributes of the object.

### (Supplementary Note 2)

The method according to supplementary note 1, wherein the receiving of the indication to detect the one or more target attributes of the object that appears in the video stream generated by the corresponding video capturing apparatus comprises:
receiving a first input relating to a selection of the corresponding video capturing apparatus; and
receiving a second input relating to a selection of a task to detect the one or more target attributes of the object,
wherein the selection of the attribute detection module is based on the first input and the second input.

### (Supplementary Note 3)

The method according to supplementary note 1 or 2, wherein each of the one or more target attributes is a target action, a first indication is received to detect one or more target actions of the object that appears in a first video stream generated by a first video capturing apparatus of the plurality of video capturing apparatuses, and the selection of the attribute detection module is based on the first indication, the method further comprising:
identifying an interaction level associated with the first video stream based on a pre-configured object interaction level corresponding to the one or more target actions, a high pre-configured interaction level of an action indicating more hardware resources being required by the attribute detection module to detect the action, wherein the allocation of the one or more of the hardware resources to process the video stream comprises allocating the one or more of the hardware resources to the attribute detection module to process the video stream and detect the one or more target actions from the first video stream based on the interaction level associated with the first video stream.

### (Supplementary Note 4)

The method according to supplementary note 3, further comprising:
selecting a highest pre-configured interaction level among two or more pre-configured interaction levels of the one or more target actions as the interaction level.

### (Supplementary Note 5)

The method according to any one of supplementary notes 1-4, wherein each of the one or more target attributes is a target object class, a second indication is received to detect one or more target object classes of the object that appears in a second video stream generated by a second video capturing apparatus of the plurality of video capturing apparatuses, and the selection of the attribute detection module is based on the second indication, the method further comprising:
identifying a number of processing neural network layers of the attribute detection module required to process the second video stream based on a pre-configured number of processing layers required to detect each of the one or more target object classes, wherein the allocation of the one or more of the hardware resources to process the video stream comprises allocating the one or more of the hardware resources to run the second video stream through the number of processing neural network layers and detect the one or more target object classes from the second video stream.

### (Supplementary Note 6)

The method according to supplementary note 5, further comprising:
selecting a higher number of processing neural network layers among two or more pre-configured number of processing neural network layers corresponding to the detection of the one or more attributes from the second video stream as the number of processing neural network layers.

### (Supplementary Note 7)

The method according to any one of supplementary notes 1-6, further comprising:
generating a result of the detection of the one or more target attributes of the object from the plurality of video streams using the one or more hardware resources allocated to the each of the plurality of video capturing apparatuses.

### (Supplementary Note 8)

An apparatus for allocating hardware resources to process a plurality of video streams generated by a plurality of video capturing apparatuses, the apparatus comprising:
at least one processor; and
at least one memory including computer program code, wherein the at least one memory and the computer program code are configured to, with at least one processor, cause the apparatus at least to:
receive an indication to configure each of the plurality of video capturing apparatuses to detect one or more target attributes of an object that appears in a video stream generated by the corresponding video capturing apparatus;
select an attribute detection module configured to detect the one or more target attributes of the object according to the indication; and allocate one or more of the hardware resources to the attribute detection module to process the video stream and detect the one or more target attributes of the object.

### (Supplementary Note 9)

The apparatus according to supplementary note 8, wherein the at least one memory and the computer program code are configured to, with at least one processor, cause the apparatus at least to:
receive a first input to configure the corresponding video capturing apparatus;
receive a second input to indicate a task to detect the one or more target attributes of the object; and
select the attribute detection module configured to detect the one or more target attributes of the object according to the indication based on the first input and the second input.

### (Supplementary Note 10)

The apparatus according to supplementary note 8 or 9, wherein each of the one or more target attributes is a target action, a first indication is received to detect one or more target actions of the object that appears in a first video stream generated by a first video capturing apparatus of the plurality of video capturing apparatuses, and the selection of the attribute detection module is based on the first indication, and
wherein the at least one memory and the computer program code are configured to, with at least one processor, cause the apparatus at least to further:
identify an interaction level associated with the first video stream based on a pre-configured interaction level corresponding to each of the one or more target actions, a high pre-configured interaction level of an action indicating more hardware resources being required by the attribute detection module to detect the action; and
allocate the one or more of the hardware resources to the attribute detection module to process the video stream and detect the one or more target actions from the first video stream based on the interaction level associated with the first video stream.

### (Supplementary Note 11)

The apparatus according to supplementary note 10, wherein the at least one memory and the computer program code are configured to, with at least one processor, cause the apparatus at least to further:
select a highest pre-configured interaction level among two or more pre-configured interaction levels of the one or more target actions as the interaction level.

### (Supplementary Note 12)

The apparatus according to any one of supplementary notes 8-11, wherein each of the one or more target attributes is a target object class, a second indication is received to detect one or more target object classes of the object that appears in a second video stream generated by a second video capturing apparatus of the plurality of video capturing apparatuses, and the selection of the attribute detection module is based on the second indication, and
wherein the at least one memory and the computer program code are configured to, with at least one processor, cause the apparatus at least to further:
identify a number of processing neural network layers of the attribute detection module required to process the second video stream based on a pre-configured number of processing neural network layers required to detect each of the one or more target object classes; and
allocate the one or more of the hardware resources to run the second video stream through the number of processing neural network layers and detect the one or more target object classes from the second video stream.

### (Supplementary Note 13)

The apparatus according to supplementary note 12, wherein the at least one memory and the computer program code are configured to, with at least one processor, cause the apparatus at least to further:
select a higher number of processing neural network layers among two or more pre-configured number of processing neural network layers corresponding to the detection of the one or more attributes from the second video stream as the number of processing neural network layers.

### (Supplementary Note 14)

The apparatus according to any one of supplementary notes 8-13, wherein the at least one memory and the computer program code are configured to, with at least one processor, cause the apparatus at least to further:
generate a result of the detection of the one or more target attributes of the object from the plurality of video streams using the one or more of the hardware resources allocated to the each of the plurality of video capturing apparatuses.

### (Supplementary Note 15)

A system for allocating hardware resources to process a plurality of video streams comprising the apparatus according to any one of supplementary notes 8-14 and a plurality of video capturing apparatuses configured to generate the plurality of video streams.

### REFERENCE SIGNS LIST

102 CAMERA
104 VIDEO STREAM
106 ANALYTIC SERVER
108 HARDWARE RESOURCES
110 NEURAL NETWORK MODEL
112 VISION ANALYTIC RESULTS
400 SYSTEM
402 REQUESTOR DEVICE
408 ATTRIBUTE DETECTION SERVER
440 COORDINATION SERVE
450A-450N HOST
442A-442N SENSOR
502 SERVER OR MODULE
700 SYSTEM
702a, 702b VIDEO CAPTURING DEVICE
704 APPARATUS
706 PROCESSOR
708 MEMORY
710 DATABASE
1002 DISPLAY WINDOW
1004 CONFIGURATION PANEL
1102 OBJECT CLASSIFICATION MODULE
1302 DISPLAY WINDOW
1304 CONFIGURATION PANEL
1400 COMPUTING DEVICE
1402 DISPLAY INTERFACE
1404 PROCESSOR
1406 COMMUNICATION INFRASTRUCTURE
1408 MAIN MEMORY
1410 SECONDARY MEMORY
1412 STORAGE DRIVE
1414 REMOVABLE STORAGE DRIVE
1418 REMOVABLE STORAGE MEDIUM
1420 INTERFACE
1422 REMOVABLE STORAGE UNIT
1424 COMMUNICATION INTERFACE
1426 COMMUNICATION PATH
1430 DISPLAY
1432 AUDIO INTERFACE
1434 SPEAKER

What is claimed is:

1. A method of allocating hardware resources to process a plurality of video streams generated by a plurality of video capturing apparatuses, the method comprising:
receiving an indication to configure each of the plurality of video capturing apparatuses to detect one or more target attributes of an object that appears in a video stream generated by the corresponding video capturing apparatus;
selecting an attribute detection module configured to detect the one or more target attributes of the object according to the indication; and
allocating one or more of the hardware resources to the attribute detection module to process the video stream and detect the one or more target attributes of the object.

2. The method according to claim 1, wherein the receiving of the indication to detect the one or more target attributes of the object that appears in the video stream generated by the corresponding video capturing apparatus comprises:
receiving a first input relating to a selection of the corresponding video capturing apparatus; and
receiving a second input relating to a selection of a task to detect the one or more target attributes of the object,
wherein the selection of the attribute detection module is based on the first input and the second input.

3. The method according to claim 1, wherein each of the one or more target attributes is a target action, a first indication is received to detect one or more target actions of the object that appears in a first video stream generated by a first video capturing apparatus of the plurality of video capturing apparatuses, and the selection of the attribute detection module is based on the first indication, the method further comprising:
identifying an interaction level associated with the first video stream based on a pre-configured object interaction level corresponding to the one or more target actions, a high pre-configured interaction level of an action indicating more hardware resources being required by the attribute detection module to detect the action, wherein the allocation of the one or more of the hardware resources to process the video stream comprises allocating the one or more of the hardware resources to the attribute detection module to process the video stream and detect the one or more target actions from the first video stream based on the interaction level associated with the first video stream.

4. The method according to claim 3, further comprising:
selecting a highest pre-configured interaction level among two or more pre-configured interaction levels of the one or more target actions as the interaction level.

5. The method according to claim 1, wherein each of the one or more target attributes is a target object class, a second indication is received to detect one or more target object classes of the object that appears in a second video stream generated by a second video capturing apparatus of the plurality of video capturing apparatuses, and the selection of the attribute detection module is based on the second indication, the method further comprising:
identifying a number of processing neural network layers of the attribute detection module required to process the second video stream based on a pre-configured number of processing layers required to detect each of the one or more target object classes, wherein the allocation of the one or more of the hardware resources to process the video stream comprises allocating the one or more of the hardware resources to run the second video stream through the number of processing neural network layers and detect the one or more target object classes from the second video stream.

6. The method according to claim 5, further comprising:
selecting a higher number of processing neural network layers among two or more pre-configured number of processing neural network layers corresponding to the detection of the one or more attributes from the second video stream as the number of processing neural network layers.

7. The method according to claim 1, further comprising:
generating a result of the detection of the one or more target attributes of the object from the plurality of video streams using the one or more hardware resources allocated to the each of the plurality of video capturing apparatuses.

8. An apparatus for allocating hardware resources to process a plurality of video streams generated by a plurality of video capturing apparatuses, the apparatus comprising:
at least one processor; and
at least one memory including computer program code,
wherein the at least one memory and the computer program code are configured to, with at least one processor, cause the apparatus at least to:
receive an indication to configure each of the plurality of video capturing apparatuses to detect one or more target attributes of an object that appears in a video stream generated by the corresponding video capturing apparatus;
select an attribute detection module configured to detect the one or more target attributes of the object according to the indication; and
allocate one or more of the hardware resources to the attribute detection module to process the video stream and detect the one or more target attributes of the object.

9. The apparatus according to claim 8, wherein the at least one memory and the computer program code are configured to, with at least one processor, cause the apparatus at least to:
receive a first input to configure the corresponding video capturing apparatus;
receive a second input to indicate a task to detect the one or more target attributes of the object; and
select the attribute detection module configured to detect the one or more target attributes of the object according to the indication based on the first input and the second input.

10. The apparatus according to claim 8, wherein each of the one or more target attributes is a target action, a first indication is received to detect one or more target actions of the object that appears in a first video stream generated by a first video capturing apparatus of the plurality of video capturing apparatuses, and the selection of the attribute detection module is based on the first indication, and
wherein the at least one memory and the computer program code are configured to, with at least one processor, cause the apparatus at least to further:
identify an interaction level associated with the first video stream based on a pre-configured interaction level corresponding to each of the one or more target actions, a high pre-configured interaction level of an action indicating more hardware resources being required by the attribute detection module to detect the action; and
allocate the one or more of the hardware resources to the attribute detection module to process the video stream and detect the one or more target actions from the first video stream based on the interaction level associated with the first video stream.

11. The apparatus according to claim 10, wherein the at least one memory and the computer program code are configured to, with at least one processor, cause the apparatus at least to further:
select a highest pre-configured interaction level among two or more pre-configured interaction levels of the one or more target actions as the interaction level.

12. The apparatus according to claim 8, wherein each of the one or more target attributes is a target object class, a second indication is received to detect one or more target object classes of the object that appears in a second video stream generated by a second video capturing apparatus of the plurality of video capturing apparatuses, and the selection of the attribute detection module is based on the second indication, and
wherein the at least one memory and the computer program code are configured to, with at least one processor, cause the apparatus at least to further:
identify a number of processing neural network layers of the attribute detection module required to process the second video stream based on a pre-configured number of processing neural network layers required to detect each of the one or more target object classes; and
allocate the one or more of the hardware resources to run the second video stream through the number of processing neural network layers and detect the one or more target object classes from the second video stream.

13. The apparatus according to claim 12, wherein the at least one memory and the computer program code are configured to, with at least one processor, cause the apparatus at least to further:
select a higher number of processing neural network layers among two or more pre-configured number of processing neural network layers corresponding to the detection of the one or more attributes from the second video stream as the number of processing neural network layers.

14. The apparatus according to claim 8, wherein the at least one memory and the computer program code are configured to, with at least one processor, cause the apparatus at least to further:
generate a result of the detection of the one or more target attributes of the object from the plurality of video streams using the one or more of the hardware resources allocated to the each of the plurality of video capturing apparatuses.

15. A system for allocating hardware resources to process a plurality of video streams comprising an apparatus and a plurality of video capturing apparatuses configured to generate the plurality of video streams, wherein;
the apparatus comprises:
at least one processor; and
at least one memory including computer program code,
wherein the at least one memory and the computer program code are configured to, with at least one processor, cause the apparatus at least to:
receive an indication to configure each of the plurality of video capturing apparatuses to detect one or more target attributes of an object that appears in a video stream generated by the corresponding video capturing apparatus;
select an attribute detection module configured to detect the one or more target attributes of the object according to the indication; and
allocate one or more of the hardware resources to the attribute detection module to process the video stream and detect the one or more target attributes of the object.

16. The system according to claim 15, wherein the at least one memory and the computer program code of the apparatus are configured to, with at least one processor, cause the apparatus at least to:
receive a first input to configure the corresponding video capturing apparatus;
receive a second input to indicate a task to detect the one or more target attributes of the object; and
select the attribute detection module configured to detect the one or more target attributes of the object according to the indication based on the first input and the second input.

17. The system according to claim 15, wherein each of the one or more target attributes is a target action, a first indication is received to detect one or more target actions of the object that appears in a first video stream generated by a first video capturing apparatus of the plurality of video capturing apparatuses, and the selection of the attribute detection module is based on the first indication, and
wherein the at least one memory and the computer program code of the apparatus are configured to, with at least one processor, cause the apparatus at least to further:
identify an interaction level associated with the first video stream based on a pre-configured interaction level corresponding to each of the one or more target actions, a high pre-configured interaction level of an action indicating more hardware resources being required by the attribute detection module to detect the action; and
allocate the one or more of the hardware resources to the attribute detection module to process the video stream and detect the one or more target actions from the first video stream based on the interaction level associated with the first video stream.

18. The system according to claim 17, wherein the at least one memory and the computer program code of the apparatus are configured to, with at least one processor, cause the apparatus at least to further:
select a highest pre-configured interaction level among two or more pre-configured interaction levels of the one or more target actions as the interaction level.

19. The system according to claim 15, wherein each of the one or more target attributes is a target object class, a second indication is received to detect one or more target object classes of the object that appears in a second video stream generated by a second video capturing apparatus of the plurality of video capturing apparatuses, and the selection of the attribute detection module is based on the second indication, and
wherein the at least one memory and the computer program code of the apparatus are configured to, with at least one processor, cause the apparatus at least to further:
identify a number of processing neural network layers of the attribute detection module required to process the second video stream based on a pre-configured number of processing neural network layers required to detect each of the one or more target object classes; and
allocate the one or more of the hardware resources to run the second video stream through the number of processing neural network layers and detect the one or more target object classes from the second video stream.

20. The system according to claim 19, wherein the at least one memory and the computer program code of the apparatus are configured to, with at least one processor, cause the apparatus at least to further:
select a higher number of processing neural network layers among two or more pre-configured number of processing neural network layers corresponding to the detection of the one or more attributes from the second video stream as the number of processing neural network layers.
